(19) United States
(12) Patent Application Publication
(10) Pub. No.: US 2005/0247402 A1
(43) Pub. Date: Nov. 10, 2005

(54) Adhesive film

(76) Inventors: Toru Fujiki, Ibaraki (JP); Toshiki Mori, Ibaraki (JP); Toshiyuki Hasegawa, Ehime (JP); Hironobu Iyama, Ehime (JP)

Correspondence Address: BIRCH STEWART KOLASCH & BIRCH, PO BOX 747, FALLS CHURCH, VA, 22040-0747, US

(21) Appl. No.: 10/525,067

(22) PCT Filed: Aug. 20, 2003
(86) PCT No.: PCT/JP03/10479

§ 371 Date: Feb. 18, 2005

(30) Foreign Application Priority Data
Aug. 23, 2002 (JP) 2002-243127

(51) Int. Cl. B32B 31/00

(52) U.S. Cl. 156/273.3

(57) ABSTRACT

The present invention provides an adhesive film obtainable by irradiating electron beam on a molded article obtainable by molding a resin composition comprising components (A) and (B), the storage method of the film and a laminate comprising the adhesive film and an adherent. Component (A) is an epoxy group-containing copolymer obtainable by polymerizing, wherein (a₁) is ethylene and/or propylene, and (a₂)is a monomer represented by formula (1): 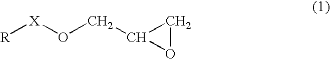
(wherein R represents a hydrocarbon group of a carbon number of 2 to 18 having a double bond, wherein at least one of hydrogen atoms of the hydrocarbon group may be substituted with a halogen atom, a hydroxyl group or a carboxyl group, and X represents a single bond or a carbonyl group). Component (B) is a copolymer obtainable by polymerizing (b₁) and (b₂), wherein (b₁) is ethylene and/or propylene, and (b₂) is α,β-unsaturated carboxylic acid anhydride.

### FIELD OF THE INVENTION

The present invention relate to an adhesive film obtainable by molding a resin composition comprising an epoxy group-containing copolymer and an ethylene-α,β-unsaturated carboxylic acid anhydride copolymer.

### BACKGROUND ART

In the field of electric and electronic parts, thinning and down-sizing are being progressed. As adhesives for electric and electronic part, for example, semiconductor encapsulating materials, electronic part encapsulating materials such as solar cells and EL (electroluminescence) lamps, die bonding sheets between integrated circuit/substrate and an interlayer insulating layer between substrates, an insulating varnish such as an epoxy resin is generally used because it is excellent in heat resistance to solder and adhesive property.

It has been recently required that a form before curing of an adhesive is a dry film-like form in order to simplify the production step of electric and electronic parts. An adhesive film which was obtained by forming a film from an adhesive composition in which an epoxy resin and a curing agent are main components and further partially curing the formed film by heating and the like (B stage formation) is also commercially available.

Then, the present inventors have studied a case that onto printed wiring plate (adherent) in which a copper wiring is provided on a substrate, the adhesive film of an epoxy resin (which was obtained after the B stage) is used as an interlayer-insulation layer. Specifically, it has been revealed that, when the adherent and the adhesive film were laminated with each other and then were heated and pressurized to be bonded, there seemed to be a problem that the resin component of the adhesive film flowed out and protruded out of the adherent. Also, it has been revealed that, when the adhesive film was further cured so as to prevent the flowing of the resin component, it did not adhere well in condition in which the adhesive film was buried in the unevenness of the copper wiring, and as a result, foams were generated between the film after curing and the adherent, and adhering property is inferior.

### DISCLOSURE OF THE INVENTION

An object of the present invention is to provide an adhesive film containing an epoxy resin which has characteristics having strength at thin film molding and being excellent in film processability and excellent in storage stability before adhesion, and which can adhere on an adherent without the flowing of the resin component in an adhesion step so as to cover the adherent. Further, another object is to provide the storage method of the adhesive film and a laminate comprising the adhesive film and the adherent.

That is, the present invention relates to the following:

<1> An adhesive film obtainable by irradiating electron beam on a molded article obtainable by molding a resin composition comprising component (A) and component (B) below:
component (A): an epoxy group-containing copolymer obtainable by polymerizing monomer (a₁) and monomer (a₂) below:
monomer (a₁): ethylene and/or propylene
monomer (a₂): a monomer represented by formula (1) below: 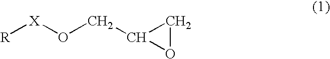
   (wherein R represents a aliphatic hydrocarbon group of a carbon number of from 2 to 18 having a double bond, at least one of hydrogen atoms of the aliphatic hydrocarbon group may be substituted with a halogen atom, a hydroxyl group or a carboxyl group, and X represents a single bond or a carbonyl group); and
component (B): a copolymer obtainable by polymerizing monomer (b₁) and monomer (b₂) below:
monomer (b₁): ethylene and/or propylene
monomer (b₂): α,β-unsaturated carboxylic acid anhydride.

<2> The adhesive film according to the above <1>, wherein the epoxy-containing copolymer of the component (A) is a melt-kneaded material.

<3> The adhesive film according to the above <1> or <2>, wherein the ratio by weight of component (A) to component (B) in the resin composition ((A)/(B)) is from 100/20 to 100/50.

<4> The adhesive film according to any one of the above <1> to <3>, wherein component (B) is a copolymer obtainable by polymerizing monomer (b₁), monomer (b₂) and at least one selected from vinyl ester and an α,β-unsaturated carboxylic acid ester.

<5> The adhesive film according to any one of the above <1> to <4>, wherein the ring-opening rate of the acid anhydride group derived from monomer (b₂) in component (B) is 1 to 50%, wherein the ring-opening rate of the acid anhydride is calculated by formula:
light absorbance [1]/light absorbance [2]×100 (%), in which light absorbance [1] is a light absorbance measured at 1850 cm⁻¹ of sample (1) with a thickness of 50 μm, obtained by heating component (B) at 150° C. for 2 minutes at normal pressure and then heating it again at 150° C. for 2 minutes under a pressurized pressure of 50 kg/cm², and light absorbance [2] is a light absorbance measured at 1850 cm⁻¹ of sample (2) with a thickness of 50 μm, obtained by heating the component (B) at 230° C. for 2 minutes at normal pressure and then heating it again at 230° C. for 2 minutes under a pressurized pressure of 50 kg/cm².

<6> The adhesive film according to any one of the above <1> to <5>, wherein the resin composition further contains an antioxidant (C).

<7> The adhesive film according to any one of the above <1> to <6>, wherein the molded article is an article obtained by extrusion-molding.

<8> The adhesive film according to any one of the above <1> to <7>, wherein the acceleration voltage of the electron beam is 50 to 300 kV.

<9> The adhesive film according to any one of the above <1> to <8>, wherein the irradiation dose of the electron beam is 10 to 300 kGy.

<10> A storage method of the adhesive film according to any one of the above <1> to <9>, wherein the adhesive film is preserved at a temperature of −10° C. or lower.

<11> A laminate obtainable by laminating the adhesive film according to any one of the above <1> to <9> on an adherent and thermally curing the adhesive film.

### BEST MODE FOR CARRYING OUT THE INVENTION

The present invention is illustrated in detail below.

A resin composition of the present invention (hereinafter, referred to as the present composition) is characterized in that it contains component (A) and component (B) below.

Component (B) in the present invention is an epoxy group-containing copolymer obtainable by polymerizing monomer (b₁), which is ethylene and/or propylene (hereinafter, referred to as monomer (b₁)), and monomer (b₂), which is a monomer represented by formula (1) below: 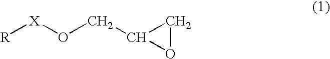
wherein R represents an aliphatic hydrocarbon group of a carbon number of from 2 to 18 having a double bond, at least one of hydrogen atoms of the aliphatic hydrocarbon group may be substituted with a halogen atom, a hydroxyl group or a carboxyl group and X represents a single bond or a carbonyl group (hereinafter, referred to as monomer (b₂)).

Inter alia, as monomer (a₁), ethylene is preferable.

In formula (1), examples of substituent R include substituents represented by formulas (2) to (8) below:

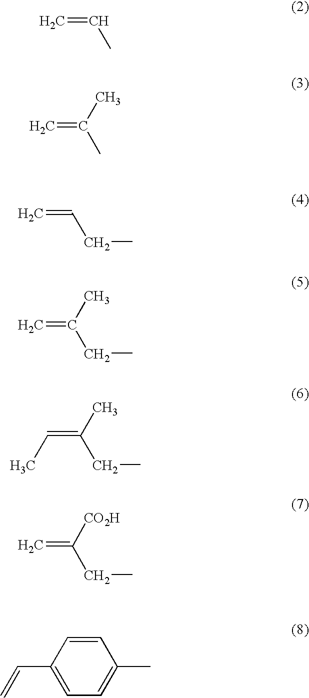

In formula (1), substituent X represents a single bond in which the oxygen atom in formula (1) and substituent R are directly bound with each other, or a carbonyl group.

Specific examples of monomer (a₂) include unsaturated glycidyl ether such as allylglycidyl ether, 2-methylallyglycidyl ether and styrene-p-glycidyl ether; and unsaturated glycidyl esters such as glycidyl acrylate, glycidyl methacrylate and itaconic acid glycidyl ester.

The content of a structural unit derived from monomer (a₂) in component (A) may be from about 1 to about 30 parts by weight relative to 100 parts by weight of component (A). When the structural unit derived from monomer (a₂) exceeds 1 part by weight, there is a tendency that adherability of the resulting adhesive film is improved, which is preferred. When the structural unit is below 30 parts by weight, there is a tendency that a mechanical strength the resulting adhesive film is improved, which is also preferred.

A monomer which is different from monomer (a₁) and monomer (a₂) and is copolymerizable with ethylene may be polymerized in component (A). Here, such a “monomer copolymerizable with ethylene” does not contain an epoxy group and a functional group capable of reacting with an epoxy group such as a carboxylic group and an acid anhydride group.

Specific examples of the “monomer copolymerizable with ethylene” include α,β-unsaturated carboxylic acid alkyl esters having an alkyl group with a carbon number of about 3 to about 8, such as methyl acrylate, ethyl acrylate, n-propyl acrylate, isopropyl acrylate, n-butyl acrylate, t-butyl acrylate, isobutyl acrylate, methyl methacrylate, ethyl methacrylate, n-propyl methacrylate, isopropyl methacrylate, n-butyl methacrylate, t-butyl methacrylate and isobutyl methacrylate; vinyl esters of carboxylic acid with a carbon number of about 2 to about 8, such as vinyl acetate, vinyl butyrate, vinyl propionate, vinyl pivalate, vinyl laurate, vinyl isononanate, and vinyl versatate; α-olefins with a carbon number of about 4 to about 20, such as 1-butene and isobutene; diene compounds such as butadiene, isoprene and cyclopentadiene; vinyl compounds such as vinyl chloride, styrene, acrylonitrile, methacrylonitrile, acrylamide and methacrylamide.

Among them, vinyl acetate, methyl acrylate, ethyl acrylate, n-butyl acrylate and methyl methacrylate are preferable, as the “monomer copolymerizable with ethylene”.

The content of a structural unit derived from the “monomer copolymerizable with ethylene” in component (A) maybe from about 0 to about 70 parts by weight, and is preferably from about 5 to about 60 parts by weight, relative to 100 parts by weight of component (A). When this content is 70 parts by weight or smaller, there is a tendency that component (A) can be easily prepared by a high pressure radical method, which is preferred.

Component (A) may be any of a block copolymer, a graft copolymer, a random copolymer and an alternating copolymer. Examples thereof include a copolymer obtained by grafting monomer (a₂) onto a propylene-ethylene block copolymer described in Japanese Patent No. 2632980; a copolymer obtained by grafting α,β-unsaturated carboxylic acid ester onto an ethylene-epoxy-group-containing monomer copolymer described in Japanese Patent No. 2600248; and the like.

Examples of a process for preparing component (A) in the present invention include:
a method of copolymerizing a monomer as a raw material under a pressure of from about 500 atm to about 4000 atm at a temperature of from about 100° C. to about 300° C. in the presence of ethylene and a radical generator, and in the presence or the absence of a proper solvent or a chain transfer agent; and
a method of mixing a monomer such as monomer (a₂) as a raw material and a radical generator with a polyethylene resin, and melt-graft-copolymerizing the resulting mixture in an extruder.

Herein, the polyethylene resin includes a homopolymer of monomer (a₁), and a copolymer of monomer (a₁) and a monomer copolymerizable with ethylene.

Component (A) in the present invention preferably has a MFR (melt flow rate; measured in accordance with JIS K7210) of from about 30 g to about 1000 g per 10 minutes, and more preferably has a MFR of from about 50 g to about 500 g per 10 minutes, under the conditions of 2.16 kg load at a temperature of 190° C. When the MFR is 30 g/10 minutes or larger, there is a tendency that flowability of the resulting adhesive film is improved and, even when there are irregularities on a surface of an adherent, they are easily embedded, which is preferred. On the other hand, when MFR is 1000 g/10 minutes or smaller, there is a tendency that heat resistance to solder, of the resulting adhesive film is improved, which is also preferred.

Component (A) may be a commercially available one and, examples thereof include “Bondfast (registered trade mark)” series (manufactured by Sumitomo Chemical Co., Ltd.) and “Rexpearl RA (registered trade mark)” series (manufactured by Nippon Polyolefin K.K.).

Component (B) in the present invention is a copolymer obtainable by polymerizing ethylene and/or propylene (hereinafter, described as monomer (b₁)) with α,β-unsaturated carboxylic acid anhydride (hereinafter, described as monomer (b₂) ).

Ethylene is preferable as monomer (b₁).

Example of monomer (b₂) includes maleic anhydride, itaconic anhydride, citraconic anhydride and the like.

Maleic anhydride is preferable as monomer (b₂).

In component (B), the “monomer copolymerizable with ethylene” described above as to component (A) may be further polymerized as a monomer therein, in addition to monomer (b₁) and monomer (b₂). Among the “monomer copolymerizable with ethylene”, vinyl acetate, methyl acrylate, ethyl acrylate, n-butyl acrylate and methyl methacrylate are preferable.

As to the contents of a structural unit derived from monomer (b₂) in component (B) and of a structural unit derived from the “monomer copolymerizable with ethylene”, the content of the structural unit derived from monomer (b₂) is may be from about 0.1 to about 20 parts by weight, and the content of the structural unit derived from the “monomer copolymerizable with ethylene” is from 0 to about 50 parts by weight, relative to 100 parts by weight of component (B).

The ring-opening rate mentioned below of the acid anhydride group (—O—CO—O—) in component (B) may be from about 1 to about 50%, and is preferably from about 10% to about 40%. When the ring-opening rate is 50% or smaller, then the storage stabilities of component (B), of a resin composition comprising component (A) and component (B) and of an adhesive film of the present invention tend to improve, and also film processability at processing the adhesive film from the resin composition tends to be improved, which are preferred. Further, when the ring-opening rate is 1% or larger, the curing rate of the adhesive film at irradiating electron beam on the resin composition and the curing rate at heating and pressuring on the adhesive film tend to improve, which is also preferred.

The measurement of ring-opening rate in the present invention is illustrated below. Firstly, a laminate system composed of a steel plate (thickness: 2 mm), an aluminum plate (thickness: 200 μm), a fluorine resin sheet (thickness: 200 μm), component (B) with a polyethylene terephthalate sheet frame (thickness: 50 μm), a fluorine resin sheet (thickness: 200 μm), an aluminum plate (thickness: 200 μm) and a steel plate (thickness: 2 mm) is prepared using component (B). After being heated at 150° C. for 2 minutes at normal pressure, the laminate system is heated at the same temperature for 2 minutes under a pressurized pressure of 50 kg/cm². Then, light absorbance (1] at 1850 cm⁻¹ is measured for sample (1) with a thickness of 50 μm derived from component (B), which is collected from the laminate system. Herein, “component (B) with the polyethylene terephthalate sheet frame (thickness: 50 μm)” means a situation where component (B) is placed at hollow center of the polyethylene terephthalate sheet frame. Further, the thickness of sample (1) derived from the component (B) obtained after heating and pressuring becomes the same thickness of 50 μm as that of the frame. Secondly, after the same laminate system including component (B) is heated at 230° C. for 2 minutes at normal pressure, the laminate system is heated at the same temperature for 2 minutes under a pressurized pressure of 50 kg/cm², and sample (2) derived from the component (B) is obtained. Then light absorbance [2] at 1850 cm⁻¹ is measured for sample (2) with a thickness of 50 μm. The ring-opening rate in the present invention is a value calculated by formula below:
light absorbance [1]/light absorbance [2]×100 (%).

Ring-opening rate is defined as described above, since acid anhydride group absorbs light at a wavelength of 1850 cm⁻¹.

Example of a production process of component (B) includes method of graft-polymerizing monomer (b₂) with a polyethylene-base resin, and the like.

The polyethylene-base resin used for component (B) may e a resin containing 50% by mol or more of a structural unit derived from monomer (b₁), and specific examples thereof include an ethylene homopolymer, an ethylene-propylene copolymer, an ethylene-1-butene copolymer, an ethylene-isobutylene copolymer, an ethylene-butadiene copolymer, an ethylene-4-methyl-1-pentene copolymer, an ethylene-isoprene copolymer, an ethylene-vinyl acetate copolymer, an ethylene-acrylate copolymer and the like.

Component (B) in the present invention preferably has a MFR (melt flow rate; measured in accordance with JIS K7210) of from about 30 g to about 1000 g per minutes, and more preferably has a MFR of from about 50 g to about 500 g per 10 minutes, under the conditions of 2.16 kg load at a temperature of 190° C. When the MFR is 30 g/10 minutes or larger, there is a tendency that a kneading temperature on processing the resulting adhesive film is lowered, and also flowability of the adhesive film is improved so that, even when there are irregularities on a surface of an adherent, they are easily embedded, which is preferred. On the other hand, when the MFR is 1000 g/10 minutes or smaller, there is a tendency that solder heat resistance of the resulting adhesive film is improved, which is also preferred.

As component (B), it is recommended to use component (B) just after production, or component (B) which has been preserved within about 2 weeks since a container of component (B) was opened and came to absorb moisture. The component (B) preserved for 2 weeks or less after the component (B) absorbed moisture is preferably used, since the ring-opening rate of the component (B) maybe from 1 to 50%, and the flowability (film processability) and storage stability at processing a film from the resulting thermosetting resin composition tend to be improved.

Further, even if component (B) has been preserved for a long time of 2 weeks or more after absorbing moisture, the film processability and storage stability of the resulting adhesive film can be improved by adjusting the ring-opening rate of the component (B) to be from 1 to50% by thermal treatment. Of course, the component (B) just after production may be thermally processed.

Example of the thermal processing of component (B) includes a method of melt-kneading component (B) usually at about 200° C. to about 250° C. with a uniaxial or biaxial screw extruder, a Bunbury mixer, a roll, various kneaders and the like.

Component (B) may be commercially available one, and examples thereof include “BONDYNE (trade mark)” series (manufactured by Sumika atfina Co.), “Rexpearl ET” series (manufactured by Polyolefin Co., Ltd.).

The present composition contains component (A) and component (B) thus obtained. Among these, a composition obtained by melt-kneading component (A) and a composition containing component (B) are preferable, and in particular, a composition obtained by mixing the melt-kneaded component (A) with component (B) and then melt-kneading again with each other is more preferable.

By the melt-kneading, generation of “fish-eye” on the adhesive film in the present invention can be reduced.

In the present composition, component (B) may be used in the amount of from 20 to 50 parts by weight, relative to 100 parts by weight of component (A). When the amount of component (B) is 20 parts by weight or more, solder heat resistance tends to be improved. When the amount of component (B) is 50 parts by weight or less, the strength of the resulting film tends to be improved and the thickness of the film can be thinned. Namely, film processability tends to be improved. Further, when the amount of component (B) is 50 parts by weight or less, the storage stability of the film tends to be improved, which is preferred.

By inclusion of an antioxidant as component (C) in addition to component (A) and component (B) in the present composition, there is a tendency that, so-called “fish eye” is suppressed in the resulting film, and storage stability of the present composition and the resulting adhesive film is improved, which is preferred.

Examples of the component (C) include a phenolic antioxidant, a phosphoric antioxidant, a sulfuric antioxidant, and an amine antioxidant. As the antioxidant, two or more kinds of antioxidants may be used by combining them. Inter alia, from a viewpoint of gel-preventing effect and coloring, it is preferred to use any of a phenolic antioxidant, a phosphoric antioxidant and a sulfuric antioxidant.

Examples of the phenolic antioxidant include 2,6-di-t-butyl-4-methylphenol, 2,6-di-t-butyl-4-ethylphenol, 2,6-dicyclohexyl-4-methylphenol, 2,6-di-t-amyl-4-methylphenol, 2,6-di-t-octyl-4-n-propylphenol, 2,6-dicyclohexyl-4-n-octylphenol, 2-isopropyl-4-methyl-6-t-butylphenol, 2-t-butyl-2-ethyl-6-t-octylphenol, 2-isobutyl-4-ethyl-6-t-hexylphenol, 2-cyclohexyl-4-n-butyl-6-isopropylphenol, d1-α-tocopherol, t-butylhydroquinone, 2,2′-methylenebis(4-methyl-6-t-butylphenol), 4,4′-butylidenebis(3-methyl-6-t-butylphenol), 4,4′-thiobis(3-methyl-6-t-butylphenol), 2,2′-thiobis(4-methyl-6-t-butylphenol), 4,4′-methylenebis(2,6-di-t-butylphenol), 2,2′-methylenebis[6-(1-methylcyclohexyl)-p-cresol], 2,2′-ethylidenebis(4,6-di-t-butylphenol), 2,2′-butylidenebis(2-t-butyl-4-methylphenol), 2-t-butyl-6-(3-t-butyl-2-hydroxy-5-methylbenzyl)-4-methyl-phenyl acrylate, 2-[1-(2-hydroxy-3,5-di-t-pentylphenyl)ethyl]-4,6-di-t-pentylphenylacrylate, 1,1,3-tris(2-methyl-4-hydroxy-5-t-butylphenyl)butane, triethylene glycol bis[3-(3-t-butyl-5-methyl-4-hydroxyphenyl)propionate], 1,6-hexanediol bis[3-(3,5-di-t-butyl-4-hydroxyphenyl)propionate], 2,2-thiodiethylenebis[3-(3,5-di-t-butyl-4-hydroxyphenyl)-propionate], N,N′-hexamethylenebis(3,5-di-t-butyl-4-hydroxy-hydro-cinnamide), 3,5-di-t-butyl-4-hydroxybenzylphosphonate diethyl ester, tris(2,6-dimethyl-3-hydroxy-4-t-butylbenzyl) isocyanurate, tris(3,5-di-t-butyl-4-hydroxybenzyl)isocyanurate, tris[(3,5-di-t-butyl-4-hydroxyphenyl)propionyloxyethyl]isocyanurate, tris(4-t-butyl-2,6-dimethyl-3-hydroxybenzyl)isocyanurate, 2,4-bis(n-octylthio)-6-(4-hydroxy-3,5-di-t-butylanilino)-1, 3,5-triazine, tetrakis[methylene-3-(3,5-di-t-butyl-4-hydroxyphenyl)-propionate]methane, 2.2′-methylenebis(4-methyl-6-t-butylphenol)terephthalate, 1,3,5-trimethyl-2,4,6-tris(3,5-di-t-butyl-4-hydroxybenzyl)-benzene, 3,9-bis[1,1-dimethyl-2-{β-(3-t-butyl-4-hydroxy-5-methyl-phenyl)propionyloxy)ethyl]-2,4,8,10-tetraoxaspiro[5,5]-undecane, 2,2-bis[4-(2-(3,5-di-t-butyl-4-hydroxyhydrocinnamoyloxy))-ethoxyphenyl]propane, and β-(3,5-di-t-butyl-4-hydroxyphenyl)propionic acid stearyl ether.

Among them, β-(3,5-di-t-butyl-4-hydroxyphenyl)-propionic acid stearyl ester, tetrakis[methylene-3-(3,5-di-t-butyl-4-hydroxyphenyl)-propionate]methane, tris(3,5-di-t-butyl-4-hydroxybenzyl)isocyanurate, 1,3,5-trimethyl-2,4,6-tris(3,5-di-t-butyl-4-hydroxybenzyl)-benzene, d1-α-tocopherol, tris(2,6-dimethyl-3-hydroxy-4-t-butylbenzyl)isocyanurate, tris[(3,5-di-t-butyl-4-hydroxyphenyl)propionyloxyethyl]-isocyanurate, and 3,9-bis[1,1-dimethyl-2-{β-(3-t-butyl-4-hydroxy-5-methyl-phenyl)propionyloxy}ethyl]-2,4,8,10-tetraoxaspiro[5,5]-undecane are preferable.

As the phenolic antioxidant, commercially available phenolic antioxidants may be used, and examples of such a commercially available phenolic antioxidants include Irganox 1010 (manufactured by Ciba Specialty Chemicals), Irganox 1076 (manufactured by Chiba Specialty Chemicals), Irganox 1330 (manufactured by Chiba Specialty Chemicals), Irganox 3114 (manufactured by Chiba Specialty Chemicals), Irganox 3125 (manufactured by Chiba Specialty Chemicals), Sumilizer BHT (manufactured by Sumitomo Chemical Co., Ltd.), Cyanox 1790 (manufactured by Cytech), Sumilizer GA-80 (manufactured by Sumitomo Chemical Co., Ltd.), and vitamin E (manufactured by Esai).

As the phenolic antioxidant, two or more of phenolic antioxidants may be used.

Examples of the phosphoric antioxidant include trioctyl phosphate, trilauryl phosphate, tridecyl phosphate, (octyl)diphenyl phosphate, tris(2,4-di-t-butylphenyl)phosphite, triphenyl phosphate, tris(butoxyethyl)phosphite, tris(nonylphenyl)phosphite, distearylpentaerythritol diphosphite, tetra(tridecyl)-1,1,3-tris(2-methyl-5-t-butyl-4-hydroxyphenyl)butane diphosphite, tetra(C₁₂˜C₁₅ mixed alkyl)-4,4′-isopropylidenediphenyl diphosphite, tetra(tridecyl)-4,4′-butylidenebis(3-methyl-6-t-butylphenol)diphosphite, tris(3,5-di-t-butyl-4-hydroxyphenyl)phosphite, tris(mono-, di-mixed nonylphenyl)phosphite, hydrogenated-4,4′-isopropylidenediphenol polyphosphite, bis(octylphenyl)bis[4,4′-butylidenebis(3-methyl-6-t-butyl-phenol)]-1,6-hexanediol diphosphite, phenyl(4,4′-isopropylidenediphenol)pentaerythritol diphosphite, distearylpentaerythritol diphosphite, tris[4,4′-isopropylidenebis(2-t-butylphenol)]phosphate, di(isodecyl)phenyl phosphite, 4,4′-isopropylidenebis(2-t-butylphenol)bis(nonylphenyl)phosphite, 9,10-dihydro-9-oxa-10-phosphaphenanthrene-10-oxide, bis(2,4-di-t-butyl-6-methylphenyl)ethyl phosphate, 2-[(2,4,8,10-tetra-t-butyldibenz[d,f][1.3.2]-dioxa-phosphepin-6-yl)oxy]-N,N-bis[2-[(2,4,8,10-tetra-t-butyl-dibenz[d,f][1.3.2]-dioxaphosphepine-6-yl}oxy]ethyl]ethane-amine, 6-[3-(3-t-butyl-4-hydroxy-5-methylphenyl)propoxy]-2,4,8,10-tetra-t-butyldibenz[d,f][1.3.2]-dioxaphosphepine.

In addition, other example compounds as the phosphoric antioxidant, such as bis(dialkylphenyl)pentaerythritol diphosphite ester, include a spiro-type compound represented by formula (9) below: 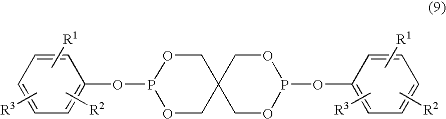
(wherein R¹, R² and R³represent independently a hydrogen atom or an alkyl group of a carbon number of from 1 to about 9), and a cage-type compound represented by formula (10) below: 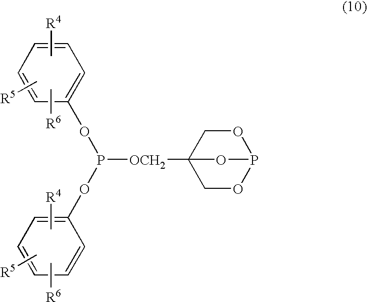
(wherein R⁴, R⁵ and R⁶ represent independently a hydrogen atom or an alkyl group of a carbon number of from 1 to about 9).

As such a phosphite ester, usually, a mixture of of compounds represented by formulas (9) and (10) may be used.

When substituents R¹ to R⁶ are alkyl groups, then branched alkyl groups are preferred and, inter alia, t-butyl groups are preferred.

In addition, as a position of substituents R¹ to R⁶ in the phenyl groups, 2, 4 and 6 positions are preferred.

Specific examples of phosphite ester as a phosphoric antioxidant include bis(2,4-di-t-butylphenyl)pentaerythritol diphosphite, bis(2,6-di-t-butyl-4-methylphenyl)pentaerythritol diphosphite, and bis(nonylphenyl)pentaerythritol diphosphite. In addition, examples of a phosphoric antioxidant, which is a phosphonite having a structure in which carbon and phosphorus are directly bound, include a compound such as tetrakis(2,4-di-t-butylphenyl)-4,4′-biphenylenediphosphonite.

As the phosphoric antioxidant, commercially available phosphoric antioxidants may be used, and examples include Irgafos 168 (manufactured by Chiba Specialty Chemicals), Irgafos 12 (manufactured by Chiba Specialty Chemicals), Irgafos 38 (manufactured by Chiba Specialty Chemicals), ADK STAB 329K (manufactured by Asahi Denka Kogyo K.K.), ADK STAB PEP 36 (manufactured by Asahi Denka Kogyo K.K.), ADK STAB PEP-8 (manufactured by Asahi Denka Kogyo K.K.), Sandstab P-EPQ (manufactured by Clariant), Weston 618 (manufactured by GE), Weston 619G (manufactured by GE), Ultranox 626 (manufactured by GE), and Sumilizer GP (manufactured by Sumitomo Chemical Co., Ltd.).

As the phosphoric antioxidant, two or more kinds of phosphoric antioxidants may be used.

Among phosphoric antioxidants, tris(2,4-di-t-butylphenyl)phosphite, tetrakis(2,4-di-t-butylphenyl)-4,4′-biphenylene diphosphanite, distearylpentaerythritol diphosphite, bis(2,4-di-t-butylphenyl)pentaerythritol diphosphite, 2-[(2,4,8,10-tetra-t-butyldibenz[d,f][1.3.2]-dioxa-phosphepin-6-yl}oxy]-N,N-bis[2-[{2,4,8,10-tetra-t-butyl-dibenz[d,f][1.3.2]-dioxaphosphepine-6-yl}oxy]ethyl]ethane-amine, and 6-[3-(3-t-butyl-4-hydroxy-5-methylphenyl)propoxy]-2,4,8,10-tetra-t-butyldibenz[d,f][1.3.2]-dioxaphosphepine are preferable.

Examples of the sulfuric antioxidant include dialkylthiodipropionate (such as dilauryl-, dimyristyl- and distearyl-thiodipropionate); and esters of polyhydric alcohols (e.g. glycerin, trimethylolethane, trimethylolpropane, pentaerythritol, trishydroxyethyl isocyanurate) with alkylthiopropionic acid (such as butyl-, octyl-, rauryl-, and stearyl-thiopropionic acid)(e.g. pentaerythryltetrakis-3-laurylthiopropionate).

Further specific examples include dilauryl thiodipropionate, dimyristyl thiodipropionate, distearyl thiodipropionate, laurylstearyl thiodipropionate, and distearyl thiodibutyrate.

Among them, pentaerythryltetrakis-3-lauryl thiopropionate is preferable.

As the sulfuric antioxidant, commercially available sulfuric antioxidants may be used, and examples thereof include Sumilizer TPS (manufactured by Sumitomo Chemical Co., Ltd.), Sumilizer TPL-R (manufactured by Sumitomo Chemical Co., Ltd.), Sumilizer TPM (manufactured by Sumitomo Chemical Co., Ltd.), and Sumilizer TP-D (manufactured by Sumitomo Chemical Co., Ltd.).

As the sulfuric antioxidant, two or more kinds of sulfuric antioxidants may be used.

Examples of the amine antioxidant include a polymer of 2,2,4-trimethyl-1,2-dihydroquinoline, 6-ethoxy-2,2,4-trimethyl-1,2-dihydroquinoline, N-(1,3-dimethylbutyl)-N′-phenyl-1,4-phenylenediamine, and N-isopropyl-N′-phenyl-1,4-phenylenediamine.

The amount of component (C) to be blended in the present composition may be from about 0.005 to about 2 parts by weight, preferably about from 0.01 to about 1 part by weight, more preferably from about 0.05 to about 0.5 part by weight, relative to 100 parts by weight of component (A).

Examples of a process for preparing the present composition include a method of melting and kneading component (A) usually at around 120° C. to 200° C. with a monoaxial or a biaxial screw extruder, a Banbury mixer, a roll or various kneaders, and mixing the resultant with component (B). Here, when the temperature of melt-kneading is within a range of from 120° C. to 200° C., the “fish-eye” of the resulting adhesive film tends to be reduced, which is preferred.

Further, it is preferred that component (C) is melt-kneaded together with component (A).

Further, additives such as a coloring agent, an inorganic filler, a processing stabilizer, a weather resistant agent, a thermal stabilizer, an optical stabilizer, a nucleating agent, a lubricant, a releasing agent, a flame-retardant, and an antistatic agent may be contained in the present composition.

When the adhesive film is utilized in a solder resist, in order to mask a conductive circuit on a surface of a printed circuit board, a dye and a pigment such as phthalocyanine green and carbon black are usually used as a coloring agent.

An adhesive film of the present invention (hereinafter, described as the present adhesive film) is a film which is obtained by extrusion-molding the present composition and then irradiating electron beam onto the molded article. The extrusion-molding method is illustrated as follows. Examples of the method include a method of melt-kneading and film-forming the composition with an extruder with a T-die. In this case, the distance (air gap) between the T-die and a chill roll is may be about 10 cm or smaller, is preferably about 8 cm or smaller, and is more preferably about 6 cm or smaller. When the air gap is 10 cm or smaller, there is a tendency that film breakage and variation (dispersion) of a film thickness generally called “one-side thick” are suppressed, which is preferred.

A melting and kneading temperature is preferably not lower than a melting temperature of a resin to be used, and not higher than about 120° C., and is more preferably from about 90° C. to about 110° C. When the melting and kneading temperature is 120° C. or lower, there is a tendency that “fish eye” of the resulting adhesive film is reduced, which is preferred.

The thickness of the present adhesive film may be from about 5 μm to about 2 mm, and is preferably from 8 μm to 1 mm.

In order to facilitate handling and storage, when extrusion-molding is carried out, the resin composition may be laminated on a support substrate, or the support substrate and the resin composition may be subjected to co-extrusion-molding together. The support substrate is preferably the substrate from which the adhesive film is easily peeled off even after curing, and examples thereof include a film composed of a 4-methyl-1-pentene copolymer, a film composed of acetyl cellulose, a polyethylene terephthalate film in which a silicone releasing agent has been coated on a side thereof to be contacted with a layer composed of a resin composition, and the like.

An electron beam to be used is a bundle of electrons accelerated with a voltage, and can be classified into low energy-type electron beam to be accelerated with a voltage of around 50 to 300 kV, intermediate energy-type electron beam to be accelerated with a voltage of around 300 to 5000 kV, and high energy-type electron beam to be accelerated with a voltage of around 5000 to 10000 kV. When applied to the present invention, a low energy-type electron beam may be usually used.

Examples of an electron accelerator include a linear cathode type, a module cathode type, a thin plate cathode type, and a low energy scanning type.

Example of a production process of the present adhesive film include a method of irradiating an electron beam on one side not covered with a support substrate, of the present film (obtained by extrusion molding) under inert gas atmosphere such as nitrogen. In this method, the other side covered with a support substrate, of the present film may be irradiated as well. Other examples of the production process include a method of peeling the support substrate off and irradiating electron beam on one side or both sides thereof, a method of peeling the support substrate, preliminarily laminating it on an adherent described later and irradiating electron beam on the resultant, and the like.

An irradiation dose of an electron beam may be around 10 to 300 kGy, and is preferably around 50 to 100 kGy. There is a tendency that when an irradiation dose is 10 kGy or larger, effect of opacifying a surface of an adherent upon rolling of a film at thermal adhesion and thermal curing is improved, which is preferred. There is a tendency that, when the dose is 300 kGy or smaller, the adhesive film is embedded in conformity with irregularities of an adherent so that adherability is improved, which is also preferred.

Even if the present adhesive film thus obtained is bonded with an adherent after being stored at about room temperature, it is rare that wrinkles are generated on the film. In other word, the present adhesive film is excellent in the storage stability, or excellent in adhesive property even after storage at room temperature. Further, when the storage temperature is −10° C. or lower, it is more recognizable that the present adhesive film is excellent in the storage stability.

The laminate of the present invention (hereinafter, described as a present laminate) can be obtained by laminating an adherent on a layer comprising the present adhesive film and curing the present adhesive film. Examples of the production process of the laminate, when the present adhesive film is not used with a support substrate, include:

1) a method of laminating an adherent on the present adhesive film and thermally curing the resultant;

2) a method of laminating an adherent on the present adhesive film, laminating another adherent and thermally curing the resultant; and the like.

Examples of the production process of the laminate, when the present adhesive film is used with a support substrate, include:

3) a method of laminating an adherent on the present adhesive film, thermally curing the resultant and peeling off the support substrate;

4) a method of laminating an adherent on the present adhesive film, peeling off the support substrate and then thermally curing the resultant;

5) a method of laminating an adherent on the present adhesive film, peeling off the support substrate, then bonding another adherent and then thermally curing the resultant; and the like.

Examples of thermal curing conditions for preparing the present laminate include a condition of maintaining a temperature of from about 140° C. to about 300° C., preferably from about 160° C. to about 200° C., for about 10 minutes to about 3 hours. There is a tendency that, when the temperature is 140° C. or higher, a thermal curing time until good solder heat resistance is obtained is shortened, which is preferred. On the other hand, when the temperature is 300° C. or lower, thermal degradation of the present adhesive film is suppressed, which is also preferred.

Further, upon thermal curing, pressurization may be performed at a pressure of 0 to 3 MPa using a heatable press machine.

Examples of a material for adherent which may be used in the present laminate include materials which can be adhered with the present adhesive film. Specific examples of the material include inorganic materials such as metals (for example, gold, silver, copper, iron, tin, lead, aluminum and silicon), glasses, and ceramics; and synthetic polymer materials such as cellulose polymer materials (for example, paper and cloth), melamine resins, acryl-urethane resins, urethane resins, a (meth)acryl resin, styrene-acrylonitrile copolymers, polycarbonate resins, phenol resins, alkyd resins, epoxy resins, and silicone resins.

A material for the adherent may be a mixture or a composite material composed of two or more kinds of materials. When the present laminate is such that different two adherents are adhered via the present adhesive film, the materials constituting the two adherents may be the same kind material or different kinds of materials.

A shape of the adherent is not particularly limited, and examples thereof include film-like, sheet-like, plate-like, and fiber-like forms.

In addition, if necessary, the adherent may be subjected to surface treatment such as releasing agent treatment, covering treatment such as plating, coating treatment with a paint containing a resin component other than the present composition, surface modifying treatment with plasma or laser, surface oxidizing treatment, and etching.

As the adherent, electric or electronic parts such as an integrated circuit and a printed circuit board that are a composite material of a polar group-containing synthetic polymer material and a metal are preferably used.

The following Examples further illustrate the invention in detail, but the present invention is not limited thereto.

Further, % and parts in Examples below are based on weight (weight basis), unless otherwise mentioned.

As components (A) and (B), the following components were used. An MFR (melt flow rate) value was measured under the conditions of 2160 g load at a temperature of 190° C., in accordance with JIS-K7210.

<Component (A)>

The following copolymers were blended and used as component (A).

Component A-1:

Component A-1 was obtained by dry-blending 100 parts of an ethylene-glycidyl methacrylate copolymer (BONDFAST CG5001, manufactured by Sumitomo Chemical Co., Ltd., ethylene unit=82%, glycidyl methacrylate unit=18%, MFR=350 g/10 min), 0.1 part of Component C-1 below, 0.1 part of Component C-2 below and 0.05 part of Component C-3, feeding the resulting mixture to a co-rotating biaxial extruder (L/D=42) of φ 30 mm in diameter, to melt-knead the mixture under a temperature of 120° C. at a screw rotation frequency of 200 rpm and a supply speed of 18 Kg/hour.

Component A-2:

Component A-2 was obtained by dry-blending 5.3 parts of carbon black (MA600, manufactured by Mitsubishi Chemical Co., Ltd.) with the same weight as above of an ethylene-glycidyl methacrylate copolymer and Components C-1 to C-3 and melt-kneading the resulting mixture in the same manner as above for obtaining Component A-1.

<Component (B)>

The following copolymers were blended and used as component (B).

Component B-1:

Component B-1 is an ethylene-maleic anhydride-ethyl acrylate copolymer (BONDYNE HX8210, manufactured by Sumika Atfina Co., Ltd., ethylene unit=91%, maleic anhydride unit=3%, ethyl acrylate unit=6%, MFR=200 g/10 min, ring-opening rate=33%).

### MEASUREMENT EXAMPLE OF RING-OPENING RATE OF COMPONENT B-1 AS COMPONENT (B)

(1) A steel plate (a thickness of 2 mm), an aluminum plate (a thickness of 200 μm), a fluorine resin sheet (a thickness of 200 μm), the copolymer of Component B-1 on a polyethylene terephthalate sheet frame (a thickness of 50 μm), a fluorine resin sheet, an aluminum plate and a steel plate were laminated in this order, and then the resulting laminate was preliminarily heated at a temperature of 150° C. for 2 minutes under a pressurized pressure of pressured pressure (50 kg/cm²) for 2 minutes, to obtain a copolymer film with a thickness of 50 μm of Component B-1. The film obtained was immediately measured by an infrared spectrophotometer to determine a light absorbance [1] at 18.50 cm⁻¹.

(2): After the lamination was carried out in the same manner as in the above (1), the laminate was preliminarily heated at a temperature of 230° C. for 2 minutes and pressed under a pressurized pressure (50 kg/cm²) for 10 minutes, to obtain a copolymer film with a thickness of 50 μm of Component B-1. The film obtained was immediately measured by an infrared spectrophotometer to determine a light absorbance [2] at 1850 cm⁻¹.

The result of [1]/[2]×100 was 33, which shows that component B-1 has a maleic-anhydride-group ring-opening rate of 33%.

<Component (C)>

The following antioxidants were used.

Component C-1:

β-(3,5-Di-t-butyl-4-hydroxyphenyl)propionic acid stearyl ester (Phenolic antioxidant, Irganox 1076 manufactured by Ciba Specialty Chemicals)

Component C-2:

Tris(2,4-di-t-butylphenyl)phosphite (Phosphoric antioxidant, Irgafos 168 manufactured by Ciba Specialty Chemicals)

Component C-3:

Pentaerythryltetrakis-3-lauryl tiopropionate (Sulfuric antioxidant, Sumilizer TP-D manufactured by Sumitomo Chemical Co., Ltd.)

### PRODUCTION EXAMPLE OF RESIN COMPOSITION

Component A-1 and Component B-1 were blended with each other in dry at the weight ratios described in Table 1, to obtain resin compositions, which were utilized in Examples 1 to 3. Component A-2 and Component B-1 were blended with each other in dry at the weight ratios described in Table 2, to obtain resin compositions, which were utilized in Examples 4 to 6.

### Production Examples 1 of Adhesive Film with a Thickness of 50 μm

Using an extruder with T-die having a diameter of 20 mm (Laboplasto Mill; manufactured by TOYO Seiki Co., Ltd.), the cylinder temperature of the extruder and the temperature of T-die were both set at 100° C., and an air gap was set at 2 cm. Then, the resin compositions obtained by dry-blending at the weight ratios described in Table 1 were melt-extruded using the above extruder on the releasing processed faces of releasing PET films (“EMBLET SC-38” with a thickness of 38 μm, manufactured by Unitika, Ltd.), to prepare double-layer films composed of adhesive films (thickness: 50 μm) and releasing PET films (thickness: 38 μm).

Successively, electron beam with doses of light shown in Table 1 was irradiated on the above-obtained double-layer films from the adhesive film sides of the films, using an electron beam irradiation equipment (manufactured by Iwasaki Denki Co., Ltd.) with an acceleration voltage of 150 kV and an irradiation light width of 600 mm, to obtain an adhesive films. The films obtained were utilized for the production of the laminates below.

The films obtained were visually observed and the generation of rashes called “fish eyes” was hardly confirmed for either of the films.

### Production Example 1 of Laminates

Onto printed circuit boards (R-1705, laminate plates copper-clad on both sides thereof, manufactured by Matsushita Electric Works, Ltd.) as adherents, the adhesive films each having a thickness of about 50 μm obtained in the above-mentioned production Example 1 were thermally clamped under at 100° C. under 3 MPa for 10 minutes, and then were thermally cured at 180° C. under 3 MPa for 60 minutes. The resin components of the adhesive films did not flow out from the adherents upon thermal clamping and thermal curing. Then, the releasing PET films were peeled off, to obtain laminates. The laminates were utilized in copper wiring-pattern built-in test shown as follow. The results were summarized in Table 1.

<Copper Wiring-Pattern Built-In Test>

Since the laminates described in Table 1 use the adhesive films not containing carbon black, the presence or absence of foams between the adhesive films and printed circuit boards could be observed with an optical microscope from the adhesive film sides. Foams were not observed in either of the laminates at all, and it was confirmed that the adhesive property between the adhesive films and the adherents was excellent.

TABLE 1

| | | Example 1 | Example 2 | Example 3 |
|---|---|---|---|---|
| Resin composition | A-1 | 75 | 75 | 75 |
| (parts) | B-1 | 25 | 25 | 25 |

| | | | |
|---|---|---|---|
| Irradiation dose of electron | 30 | 70 | 90 |
| beam (kGy) | | | |
| Presence of fish eyes in | None | None | None |
| adhesive films | | | |
| Flow-out of resin component | None | None | None |
| from adherents | | | |
| Copper wiring-pattern | ◯ | ◯ | ◯ |
| built-in test | | | |
| Solder heat resistance test | ◯ | ◯ | ◯ |
| Storage stability | ◯ | ◯ | ◯ |

### Production Example 2 of Adhesive Films: Thickness of 15 μm

Adhesive films having a thickness of about 15 μm were prepared in the same manner as in Production Example 1 except that the resin compositions obtained by dry-blending at the weight ratios described in Table 2 were used.

The films obtained were visually observed, and the generation of “fish eyes” was hardly confirmed for either of the films.

### Production Example 2 of Laminates

Laminates were obtained in the same manner as in the production Example 1 except that the adhesive films having a thickness of about 15 μm were used. The resin component of the adhesive films did not flow out from the adherents upon thermal clamping and thermal curing. The laminates were utilized in a copper wiring-masking test shown as follow.

<Copper Wiring-Masking Test>

As shown in Examples 4 to 6 of Table 2, the copper wiring-pattern was not confirmed at all in either of the laminates, and it was confirmed that the adherents were covered with the adhesive films containing carbon black.

Further, the thickness of the adhesive films with the copper wirings obtained after curing, was observed after cutting certain sections of the copper wirings, and it was confirmed that the adherents were fully covered.

TABLE 2

| | | Example 4 | Example 5 | Example 6 |
|---|---|---|---|---|
| Resin composition | A-1 | 79 | 79 | 79 |
| (parts) | B-1 | 25 | 25 | 25 |

| | | | |
|---|---|---|---|
| Irradiation dose of electron | 70 | 90 | 110 |
| beam (kGy) | | | |
| Presence of fish eyes in | None | None | None |
| adhesive films | | | |
| Flow-out of resin component | None | None | None |
| from adherents | | | |
| Copper wiring-masking test | ◯ | ◯ | ◯ |
| Solder heat resistance test | ◯ | ◯ | ◯ |
| Storage stability | ◯ | ◯ | ◯ |
| Thickness of adhesive film | 27 | 28 | 30 |
| with copper wiring after | | | |
| curing (μm) | | | |

<Solder Heat Resistance Test>

The resulting laminates obtained in the above-mentioned Production Examples 1 and 2 were immersed in a solder bath at 260° C. for 10 seconds, using SOLDERABILITY TESTER EST-11 manufactured by Tabai Espec Corp. Regarding this immersion as one cycle procedure, 6 cycles procedures were repeated, and appearance of the surfaces of the laminates were observed with naked eyes. The results are summarized in Tables 1 to 3.

Evaluation of the results of the solder heat resistance test was conducted based on the following criteria with marks ◯and x:
◯: No abnormality (such as peeling and dilation) was observed in appearance of the film evaluated, and no solder grain is observed.
x: Abnormality (such as peeling and dilation) is observed in appearance of the film evaluated, or solder grain is observed.
   <Storage Stability>

The adhesive films with a thickness of about 50 μm which were obtained in the above-mentioned Production Examples 1 and 2 were preserved under the atmosphere of a temperature of 23° C. and a humidity of 50%. Using the preserved films, the laminates were produced by every week in the same manner as in Production Examples of the laminate, and the film conditions of the surfaces of the laminates were visually observed. The results were summarized in Tables 1 and 2.

Further, evaluation was conducted based on the following criteria:
◯: A laminate having no wrinkles on the film after thermal curing.
Δ: A laminate having an area of less than 10% of wrinkles on the film after thermal curing.
X: A laminate having an area of 10% or more of wrinkles the film after thermal curing.

The results were summarized in Table 1.

As mentioned above, an adhesive film of the present invention can be used in such a way that the resin component f the adhesive film does not flow out when a laminate is produced y bonding the adhesive film on an adherent. Further, the adhesive film is excellent in storage stability and has good processability such that fish eyes are not observed. Further, the laminate obtained is excellent in solder heat resistance and adhesive property. Even if there are uneven portions on the adherent, the adherent can adhere with the adhesive film to provide a laminate in which the adhesive film can completely cover the adherent.

By utilizing such excellent properties, the laminate of the present invention can be used in semiconductor encapsulating materials, electronic part encapsulating materials for solar cells and EL (electroluminescence) lamps, die bonding sheets between integrated circuit and substrate, and interlayer insulating layers between substrates. The adhesive film can be utilized for a solder resist, which protects a substrate from a solder, a protective sheet at a step of producing electronic parts, and the like.

1. An adhesive film obtainable by irradiating electron beam on a molded article obtainable by molding a resin composition comprising component (A) and component (B) below:
component (A): an epoxy group-containing copolymer obtainable by polymerizing monomer (a₁) and monomer (a₂) below:
monomer (a₁): ethylene and/or propylene
monomer (a₂): a monomer represented by formula (1) below: 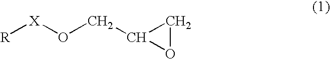
(wherein R represents a aliphatic hydrocarbon group of a carbon number of from 2 to 18 having a double bond, at least one of hydrogen atoms of the aliphatic hydrocarbon group may be substituted with a halogen atom, a hydroxyl group or a carboxyl group, and X represents a single bond or a carbonyl group); and
component (B): a copolymer obtainable by polymerizing monomer (b₁) and monomer (b₂) below:
monomer (b₁): ethylene and/or propylene
monomer (b₂): α,β-unsaturated carboxylic acid anhydride.

2. The adhesive film according to claim 1, wherein the epoxy-containing copolymer of the component (A) is a melt-kneaded material.

3. The adhesive film according to claim 1 or 2, wherein the ratio by weight of component (A) to component (B) in the resin composition ((A)/(B)) is from 100/20 to 100/50.

4. The adhesive film according to claim 1, wherein component (B) is a copolymer obtainable by polymerizing monomer (b₁), monomer (b₂) and at least one selected from vinyl ester and an α,β-unsaturated carboxylic acid ester.

5. The adhesive film according to claim 1, wherein the ring-opening rate of the acid anhydride group derived from monomer (b₂) in component (B) is 1 to 50%, wherein the ring-opening rate of the acid anhydride is calculated by formula:
light absorbance [1]/light absorbance [2]×100 (%), in which light absorbance [1] is a light absorbance measured at 1850 cm⁻¹ of sample (1) with a thickness of 50 μm, obtained by heating component (B) at 150° C. for 2 minutes at normal pressure and then heating it again at 150° C. for 2 minutes under a pressurized pressure of 50 kg/cm², and light absorbance [2] is a light absorbance measured at 1850 cm⁻¹ of sample (2) with a thickness of 50 μm, obtained by heating the component (B) at 230° C. for 2 minutes at normal pressure and then heating it again at 230° C. for 2 minutes under a pressurized pressure of 50 kg/cm².

6. The adhesive film according to claim 1, wherein the resin composition further contains an antioxidant.

7. The adhesive film according to claim 1, wherein the molded article is an article obtained by extrusion-molding.

8. The adhesive film according to claim 1, wherein the acceleration voltage of the electron beam is 50 to 300 kV.

9. The adhesive film according to claim 1, wherein the irradiation dose of the electron beam is 10 to 300 kGy.

10. A storage method of the adhesive film according to claim 1, wherein the adhesive film is preserved at a temperature of −10° C. or lower.

11. A laminate obtainable by laminating the adhesive film according to claim 1 on an adherent and thermally curing the adhesive film.
